(19) United States
(12) Patent Application Publication
(10) Pub. No.: US 2006/0015406 A1
(43) Pub. Date: Jan. 19, 2006

(54) Hybrid network based advertising system and method

(75) Inventors: Gil Beyda, Fort Washington, PA (US); Krishna Balasubramanian, Fort Washington, PA (US)

Correspondence Address: DECHERT LLP, P.O. BOX 10004, PALO ALTO, CA, 94303, US

(73) Assignee: 24/7 Real Media, Inc., New York, NY (US)

(21) Appl. No.: 11/225,935

(22) Filed: Sep. 13, 2005

Related U.S. Application Data
(63) Continuation of application No. 10/870,308, filed on Jun. 16, 2004.
Application No. 10/870,308 is a continuation of application No. 09/748,774, filed on Dec. 26, 2000, now abandoned.

(51) Int. Cl. G06Q 30/00

(52) U.S. Cl. 705/14

(57) ABSTRACT

The invention relates to a system and method for presenting advertisements to a user. A user network processing device transmits at least one user request for an advertisement and presents advertisements served in response to the user request for an advertisement to the user. A content provider server having a local ad delivery engine with local ad campaign data receives the user request for and advertisement and transmits an advertisement to the user in response to the user request for an advertisement. A central ad planning server having a database operable to store central ad campaign data, the central ad planning server periodically transmits at least a portion of the database to the content provider server to update the local ad campaign data.

### CROSS-REFERENCE TO RELATED APPLICATION

This application is a continuation of U.S. patent application Ser. No. 10/870,308, filed Jun. 16, 2004, entitled “HYBRID NETWORK BASED ADVERTISING SYSTEM AND METHOD,” which is a continuation of U.S. patent application Ser. No. 09/748,774, filed Dec. 26, 2000, entitled “HYBRID NETWORK BASED ADVERTISING SYSTEM AND METHOD.”

The present invention relates to systems and methods for distributing advertisement information via a data network such as the Internet.

In general, a user accesses the Internet World Wide Web (WWW or Web) using a network processing device such as personal computer and associated software including an operating system and Web Browser (e.g., Netscape Communicator, Microsoft Internet Explorer or the like). The Web Browser assists the user in identifying and/or inputting the network address of a given Web page or site. The address of a given Web site is generally formatted as a URL (Uniform Resource Locator), which is basically an advanced resource or file name formatted for Internet addressing. A URL typically points to a given resource such as an image or a file in a particular directory. The directory can exist on any machine on the Internet, and can be transmitted or served via one of many different protocols (e.g., HTTP, FTP, GOPHER, NEWS, NNTP, MAILTO and the like). However, typical World Wide Web documents are accessed using HTTP (Hyper-Text Transport Protocol).

A user can directly input the address of a given Web page into the address bar of the Web Browser (e.g., http://www.epl.com); where “cpl” is the second level domain name and “com” is the top level domain of the requested Web site. In the alternative, the user can select a Web site from a pre-stored list of frequently visited sites (e.g., favorites or bookmarks). The user may also click on a Hyper-Text link embedded in a Web page (e.g., based on results returned from a typical search engine) or any other “Web-enabled” application (e.g., e-mail reader, news reader, word processor or the like) which contains a link to the desired site.

When an Internet user requests information from an Internet Web site, the browser, via HTTP protocol, opens a connection and sends a request message to the desired Web server; the server then returns a response message, usually containing the resource (e.g., an HTML document) that was requested. After delivering the response, the server closes the connection. A typical Web page includes one or more advertisements (e.g., a banner ad) embedded within the HTML document. Most advertisements are associated with a hyper-text link which allows the user to link to and ultimately view additional information such as an advertiser's Web site.

Many Web sites sell advertising space to one or more advertisers. If several advertisements or advertisement campaigns are available, it is desirable to select an advertisement that is most likely to elicit a favorable response from the user. Various methods exist for targeting advertisements to a given user or user profile. It is also desirable to collect statistics in order to evaluate the performance of a given advertising campaign.

Several methods are also available for delivering advertisement information to an Internet user and tracking the performance a given advertisement campaign. However, currently available solutions fall into two general categories, local or central. The term local generally refers to an “in house” configuration in which the installation, operation and control of the ad management software and data are at the content provider Web site. The term central generally refers to an “out-sourced” configuration in which the ad management software is installed, maintained and controlled by a third party at a remote location, separated from the content provider Web site. The ad server, database management software and all associated data are controlled by the out-sourcing company.

A local ad management system is disclosed in U.S. Pat. No. 5,937,392—Alberts. The system has a local database (and database engine), controller and ad server operating in conjunction with a Web site. The ad server communicates with the ad controller and database (via the database engine). The database contains information defining the parameters for the display of ads (advertising campaign data). The controller accesses information in the database and provides the information to the ad server. The ad server receives and stores the information in tables and is operable to control which ads are served to Web site users. The controller receives statistics from the ad server and transfers the statistics to the database for storage.

Local ad management solutions are commercially available from various sources including: Doubleclick, Inc. of New York, N.Y., and Engage Technologies of Andover, Mass. Local ad management systems are advantageous since the content provider can control all aspects of ad delivery as well as tracking and reporting functions. However, the content provider must also purchase, install and maintain all of the hardware and software associated with ad management system.

In contrast, centrally hosted ad management solutions are commercially available from various sources including: DART products available from Doubleclick, Inc. of New York, N.Y., AdKnowledge products available from Engage Technologies of Andover, Mass. Centrally hosted ad management solutions typically utilize a third party advertisement server that is responsible for operation and control of ad management software and all associated data. In operation, an Internet user requests content from the content provider. Before the content provider can return content (i.e., an HTML document) advertisement information must be requested from the third party advertisement server. The third party advertisement server receives the request, identifies the requesting server and/or user, queries its databases and selects an appropriate advertisement. The third party advertisement server then responds to the content provider with the URL of the advertisement information (e.g., banner ad). The content provider modifies or rewrites its HTML code to reference the advertisement served by the third party advertisement server. The modified HTML code is served to the user with the properly identified advertisement information.

An exemplary HTML code fragment for a typical banner ad as rewritten by the content provider is shown below:

<A HREF=“www.tp1.com/ad/ad1”>
<IMG SRC =“www.tp1.com/ad/ad1.gif”></A>

In this example, the third party advertisement server (located at tpl.com) is the source of the banner ad (adl.gif). The URL identified in the “A HREF” tag is also located within the third party domain and provides click though tracking prior to directing the user to the advertiser's Web site (e.g., adl.com).

Some content providers rewrite the HTML code to provide internal click through tracking as shown in the HTML fragment below:

<A HREF=“www.cp1.com/ . . . /www.tp1.com/ad/ad1”>
<IMG SRC =“www.tp1.com/ad/ad1.gif”></A>

In this example, the URL identified in the “A HREF” tag is located within the content provider's domain (cpl.com) and provides click though tracking prior to directing the user to the third party advertiser's domain (e.g., tpl.com) and ultimately the advertiser's Web site (e.g., adl.com).

Since many advertisements are served by a single third party advertisement server, user activity is easily correlated and tracked. When the user loads Web pages from various Web sites, every advertisement served by the third party server will result in an HTTP call to the third party server for an advertisement. Each HTTP call will return a cookie associated with the third party server's domain (identifying the user's ID). The third party server can also identify the referring Web site or domain by other means. Based on these pieces of information, the third party can compile a profile of a given user.

Centrally hosted ad management solutions are advantageous since the content provider need not purchase, install or maintain any of the hardware and software associated with ad management system. However, the content provider has limited control over ad delivery parameters, tracking and reporting functions.

Other systems and methods for serving or allocating advertisement information and gathering statistical information relating to Internet based advertisements are shown in U.S. Pat. No. 5,796,952—Davis et al., U.S. Pat. No. 5,948,061—Merriman et al., U.S. Pat. No. 5,991,740—Messer, U.S. Pat. No. 6,006,197—d'Eon et al. and U.S. Pat. No. 6,026,369—Capek. These references as well as U.S. Pat. No. 5,937,392 are hereby incorporated by reference.

What is needed in the art, and provided by the invention, are simple and effective systems and methods that allow content providers maximum control over ad delivery parameters, tracking and reporting functions and minimize the labor and expense associated with purchasing, installing and maintaining all hardware and software associated with an ad management system.

### SUMMARY OF THE INVENTION

A preferred aspect of the invention relates to a system and method for presenting advertisements to a user. A user network processing device preferably transmits at least one user request for an advertisement and presents advertisements served in response to the user request for an advertisement to the user. A content provider server having a local ad delivery engine with local ad campaign data preferably receives the user request for and advertisement and transmits an advertisement to the user in response to the user request for an advertisement. A central ad planning server having a database operable to store central ad campaign data, the central ad planning server preferably periodically transmits at least a portion of the database to the content provider server to update the local ad campaign data.

In another aspect of the invention, the ad delivery engine is operable to select an advertisement from the local ad campaign data based on at least one of a user data, content data, date, time, host name, available campaigns, targeting data and scheduling data.

In another aspect of the invention, the ad delivery engine is operable to periodically receive a campaign data file containing at least a portion of the database from the central ad planning server.

In another aspect of the invention, the ad delivery engine is operable to update the local ad campaign data with data from the campaign data file.

In another aspect of the invention, the ad delivery engine maintains a campaign data log with data relating to advertisements served.

In another aspect of the invention, the campaign data log contains data relating to at least one of an advertisement campaign, user data, advertisement placement, host name, date and time.

In another aspect of the invention, the ad delivery engine is operable to periodically transmit the campaign data log to the central ad planning server.

In another aspect of the invention, the central ad planning server is operable to update the database based on the campaign data log.

In another aspect of the invention, the database contains data related to a plurality of advertising campaigns.

In another aspect of the invention, the central ad planning server is operable to add, modify or delete data relating to at least one of the plurality of advertising campaigns stored in the database.

In yet another aspect of the invention, the central ad planning server is operable to generate at least one report based on data contained in the database, the report containing data related to at least one of ad inventory and ad campaign performance.

### BRIEF DESCRIPTION OF THE DRAWINGS

FIG. 1 is a block diagram showing a user PC, content provider Web server having a local ad delivery engine, central ad planning server and an advertiser server in data communication in accordance with the invention;

FIG. 2 is a block diagram showing the basic functionality of a local ad delivery engine in accordance with the invention;

FIG. 3 is a block diagram showing the basic structure of an exemplary campaign data log in accordance with the invention;

FIG. 4 is a block diagram showing the basic structure of an exemplary campaign data file in accordance with the invention; and

FIG. 5 is a block diagram showing the basic functionality of a central ad planning server in accordance with the invention.

### DETAILED DESCRIPTION OF THE INVENTION

Definitions

The following terms shall have, for the purposes of this application, the respective meanings set forth below.
Ad Delivery Engine: generally refers to a software program that is operable to receive a request for an advertisement, and transmit a locally stored advertisement in response to the request. The ad delivery engine is also preferably operable to periodically receive (e.g., from the central ad planning server) advertising campaign data for incorporation into the local ad campaign data.
Campaign Data File: generally refers to a file that identifies and/or contains information relating to one or more advertisement campaigns associated with the content provider server.
Campaign Data Log: generally refers to a log file that identifies and/or contains information relating to the particular advertisements served by the local ad delivery engine over a period of time. The campaign data log preferably identifies the advertisement (or advertisement campaign), the ID of all users to which the advertisement was served, advertisement placement information, host name, date and time.
Central Ad Planning Server: generally refers to a server that is operable to store central ad campaign data. The central ad planning server is preferably operable to periodically transmit at least a portion of the central ad campaign data to the content provider server to update the local ad campaign data.
Content Provider Server: generally refers to a server that provides information or content via a data network such as an HTTP server hosting an Internet Web site.
Cookie: generally refers to a message or tag transmitted from a Web server and stored by a Web Browser. The Browser typically stores the cookie in a text file or directory. Each cookie typically contains one or more pieces of information in “name=value” paired format (e.g., ID=123, Domain=cpl.com, Age=37 and the like). The cookie is then sent back to the Web server each time the Browser requests that page from the Web server.
Data network: generally refers to a group of two or more computer systems linked together in data communication. There term encompasses any type of computer network, independent of protocol, including local-area networks (LANs), wide-area networks (WANs) and networks of networks including the an intranet, extranet and the Internet.
HTML: generally refers to Hyper-Text Markup Language, the authoring language used to create documents on the World Wide Web. HTML defines the structure and layout of a Web document by using a variety of tags and attributes.
Link: generally refers to an HTML element that provides a Hyper-Text link. For example an HTML element supporting the HREF attribute, specifying a Hyper-Text link to another resource such as an HTML document, image or the like.
Local Ad Campaign Data: generally refers to local data (e.g., stored in a database) associated with ad campaigns available to the content provider server.
Network processing device: generally refers to a network processing location or node. A network processing device includes but is not limited to a computer (such as a PC) portable or hand held computer device, other network enabled device (such as a Browser phone), or some other device, such as a printer. Each network processing device is typically assigned unique network address.
Resource: generally refers to any hardware or software item that can be used on a network. The term as it is recited herein primarily refers to data or routines that are available to network processing devices such as network servers, peers and/or clients (i.e., Web Browsers) and the like.
Rsync: generally refers to an open source utility that provides incremental file transfer. Rsync is freely available under the GNU General Public License
Server: generally refers to a program running on a computer which provides some service to other (e.g., client) programs.
User Network Processing Device: generally refers to a user operable device having access to the data network including but not limited to a personal computer (portable or desktop), personal digital assistant (PDA), Browser phone, 2-way pager or the like. A user network processing device can be operated by an individual or may be programmed to operate automatically (i.e., timed schedule or triggered by an external event).

It is understood that all references to Internet domain names such as cpl.com, tpl.com, adl.com and the like are used herein for illustrative purposes only. These domain names have no correlation to any individual or business entity with an identical or similar Internet domain name previously or currently in use on the Internet or any individual or business entity adopting an identical or similar Internet domain name in the future.

The invention concerns a data network communication system and method for presenting advertisements to a user. The terms “present” or “presenting” as used herein are used in their ordinary sense and include displaying or playing audio and/or visual information to a user. The data network generally includes a plurality of nodes such as a user network processing device, content provider server, central ad planning server and an advertiser server coupled in data communication. The term “coupled” as recited herein is used in its broadest sense and does not require a physical connection between devices. Two or more devices as disclosed herein are “coupled” so long as data communication between the devices is possible (e.g., hard wired data communication, wireless data communications and the like).

In the context of the Internet, many types of network servers are available to provide resources to a user such as those for Network File System, Network Information Service (NIS), Domain Name System (DNS), FTP, news, finger, Network Time Protocol and the like. The connection between two network nodes or a client and server is normally by means of message passing, over the data network, and uses some protocol (such as TCP/IP) to encode the client's requests and the server's responses. Typical servers may run continuously (as a daemon), waiting for requests to arrive or may be invoked by some higher level daemon which controls a number of specific servers.

The term “user network processing device” generally refers to any user operable device having access to the data network including but not limited to a personal computer (portable or desktop), personal digital assistant (PDA), Browser phone, 2-way pager or the like. The user network processing device can be operated by an individual or may be programmed to operate automatically (i.e., timed schedule or triggered by an external event). Thus, the term “user” as recited herein encompasses an individual as well as a computerized device operable to access the data network and perform computer automated functions.

In the context of the Internet, the user network processing device, content provider server, central ad planing server and advertiser server all communicate via TCP/IP protocol (Transmission Control Protocol over Internet Protocol). Each is network addressable in that it has a specific IP address (i.e., the 32-bit address defined by the Internet Protocol usually represented in dotted decimal notation) which is used to route data between the devices.

The user network processing device is operable to transmit at least one user request for an advertisement and present an advertisement served in response to the user request for an advertisement to the user. The content provider server has a local ad delivery engine with local ad campaign data and is operable to receive the user request for an advertisement, and transmit an advertisement to the user in response to the user request for an advertisement.

The central ad planning server has a database operable to store central ad campaign data. The central ad planning server is operable to periodically transmit at least a portion of the database to the content provider server to update the local ad campaign data.

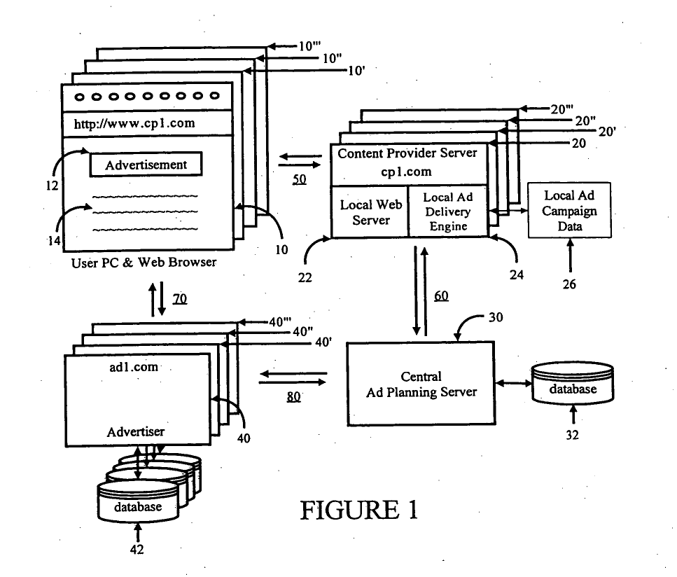

FIG. 1 shows a general block diagram of a user network processing device (user PC and Web Browsers 10, 10′, 10″, 10′″), content provider servers 20, 20′, 20″, 20′″, central ad planning server 30, and advertiser servers 40, 40′, 40″, 40′″ in data communication via the Internet in accordance with the invention. The central ad planning server 30 is operable to communicate with a plurality of content provider servers and store advertisement data relating to a plurality of advertisers as shown in FIG. 1. For matters of simplicity the user PC and Web Browser 10, content provider server 20 and advertiser server 40 are discussed in detail below. It is understood that invention encompasses systems having a plurality of user network processing devices, content provider servers and advertiser servers all of which cooperate (directly or indirectly) with a single central ad planning server.

FIG. 1 generally shows the data communications paths between the user PC and Web Browser 10, content provider server 20, central ad planning server 30 and advertiser server 40 in loading a typical Web page containing an advertisement 12 and content 14 served by the content provider server 22. Communications between user PC and Web Browser 10, content provider server 20, central ad planning server 30 and advertisement server 40 are generally shown by arrows 50, 60, 70 and 80. It is understood that data communications via the Internet often traverse a series of intermediate network nodes prior to reaching the desired destination (e.g., the user PC and Web Browser or the content provider Web site). Arrows 50, 60, 70 and 80 do not suggest a direct physical connection between the user PC and Web Browser 10 and/or various servers and encompass typical Internet communications (a connectionless, best-efforts packet-based system). It is also understood that other data networks using various network protocols are suitable for use in accordance with the invention.

The user PC and Web Browser 10 is operable to accesses the Internet World Wide Web (WWW or Web). The user PC is preferably has an associated operating system such as Microsoft Windows or Linux and includes a typical Web Browser such as Netscape Communicator (for Windows or Linux) or Microsoft Internet Explorer, as well as numerous others. The Web Browser assists the user in requesting and displaying Web pages or sites containing desired information. The hardware and software configuration of a user network processing device for Internet access is routine and generally known to those skilled in the art.

The content provider server 20 and advertiser server 40 are preferably HTTP servers hosting a Web site (e.g., cpl.com, adl.com). There are many varieties of commercially or publicly available World Wide Web server software packages which are compatible with the invention (e.g., Apache, IBM WebSphere products, NETSCAPE Enterprise, Microsoft Windows 2000 Server and the like) all of which can be implemented with commonly available hardware from vendors such as IBM, Hewlett Packard, Compaq, Dell, Sun and numerous others that are known to those skilled in the art. Content provider server 20 and advertiser server 40 can optionally transfer data via other known protocol or combinations of protocols including but not limited to HTTP, FTP, SMTP or the like.

Central ad planning server 30 is preferably an HTTP server and can be at least partially implemented using commercially or publicly available server software and commonly available hardware from vendors such as IBM, Hewlett Packard, Compaq, Dell, Sun and numerous others that are known to those skilled in the art. Central ad planning server can optionally transfer data via other known protocol or combinations of protocols including but not limited to HTTP, FTP, SMTP or the like. The specific function of the central ad planning server is set forth in more detail below.

Content provider server 20 is not only operable to serve Web pages but has a local ad delivery engine generally operable to select an ad for delivery to the user and serve or transmit the ad in response to requests for resources. Each advertisement is linked to an advertiser Web site (e.g., located at adl.com) that can be accessed by the user in response to the advertisement information displayed by the user's Web Browser (e.g., via an HTML link to the advertiser's Web site).

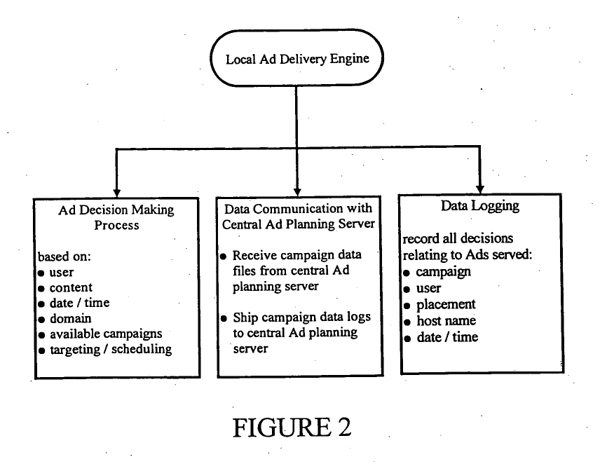

FIG. 2 is a block diagram showing the basic functionality of a local ad delivery engine 24 in accordance with the invention. The local ad delivery engine provides three basic functions, ad decision making, data communications with the central ad planning server and data logging. A user interface generally provides user access, control and/or configuration of local ad delivery engine functions.

Local Ad Delivery Engine—Ad Decision Making Process

The local ad delivery engine 24 generally has access to all information necessary to select an advertisement (from a plurality of advertisements) to be served in response to a user request. Data relating to the available ad campaigns is locally stored in relation to the content provider server. See FIG. 1, block 26. The local ad delivery engine and local ad campaign data is controlled by the content provider. That is, the content provider may alter ad delivery parameters based on various combinations of the local ad campaign data as well as other data. The content provider is also responsible for maintaining these aspects of the system. Accordingly, the term “local” as used herein denotes that a particular party (e.g., the content provider) has control over specific elements of the system.

In a preferred embodiment local ad delivery engine 24 is integrated into the local Web server 22 associated with the content provider server 20. Similarly, local ad campaign data 26 is preferably stored in memory (e.g., RAM, hard disk and the like) within the content provider server 20. In an alternate embodiment local ad delivery engine 24 and/or local ad campaign data 26 can be associated with a separate server and/or computer. However, in all cases, the content provider has control over these elements of the system.

The local ad campaign data 26 is essentially a local database of ad campaigns available to the content provider server 20 and includes information specific to each campaign including address information for banner ad images, scheduling data, targeting data and the like. The ad delivery engine is operable to select an advertisement from the local ad campaign data based on at least one of a user data (e.g., user ID, User preferences and the like), content data, date, time, host name, available campaigns, targeting data and scheduling data.

The user data is generally available to the content provider server and local ad delivery engine via a cookie transmitted to the content provider server along with the request for resources. Content data is generally related to and/or identifies the content of the referring Web site and is derived by conventional means. The data, time and host name are also derived by conventional means.

Ii general, the ad delivery engine selects an advertisement by combining data related to the user request to the targeting and/or scheduling data contained in the local ad campaign data. Once the ad is selected it is served to the user and logged in a campaign data log as discussed below.

Local Ad Delivery Engine—Data Communications and Data Logging

The ad delivery engine is operable to periodically receive (from the central ad planning server) at least a portion of the central ad planning server database 32 for incorporation into the local ad campaign data. In general, the portion of database information is packaged in a campaign data file that identifies one or more of the active advertisement campaigns associated with the content provider server 20. The portion of database information can include some or all of an ad campaign's parameters (e.g., targeting data, scheduling data and the like). The structure of the campaign data file is discussed in detail below.

Transfer of the campaign data file is preferably initiated by the central ad planning server 30. In the alternative, transfer of campaign data file can be initiated by the ad delivery engine 24. Preferably, the campaign data file is transferred to the ad delivery engine in response to an external event (e.g., a change in ad campaign parameters, end of a campaign, addition of a new campaign or the like). In the alternative, the campaign data file can be transferred to the ad delivery engine on a scheduled basis (e.g., once a day). Thus, the terms “periodic” or “periodically” refers not only regularly scheduled events (i.e., hour, daily or the like) but also intermittent or asynchronously occurring events.

The ad delivery engine is also operable to periodically transmit a campaign data log to the central ad planning server. The campaign data log generally contains data identifying the particular advertisements served by the local ad delivery engine over a period of time. The campaign data log preferably identifies the advertisement (or advertisement campaign), the ID of all users to which the advertisement was served, advertisement placement information, host name, date and time.

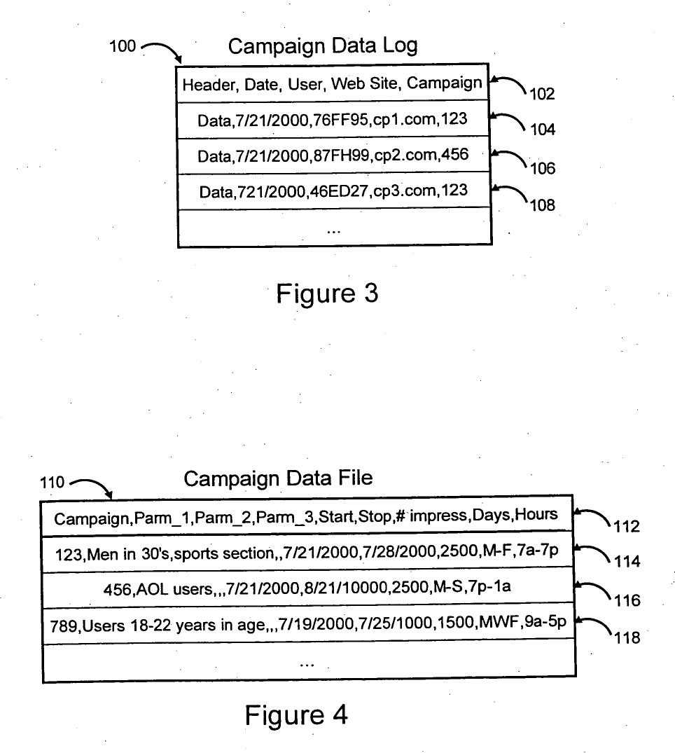

An exemplary campaign data log 100 is shown if FIG. 3. In this example, the campaign data log is a variable format, comma delimited, text file having a plurality of records 102, 104, 106, 108. Preferably, the campaign data log includes both header and data records. Header records preferably define the structure of subsequent data records. It is understood that the campaign data log is not limited to the example shown in FIG. 3 and can include several header records that define a plurality of different fields. In the current example, header record 102 (beginning with “Header”) specifies the format of subsequent data records (e.g., date, User ID, web site address, campaign identification). Each data record (beginning with “Data”) 104, 106 108 includes data in the format defined by the previous header record 102. For example, data record 104 identifies the date (Jul. 21, 2000) and User ID (76FF95) as well as the web site (epl.com) to which particular advertisement campaign data was served (123). Based on the foregoing, the remaining data records are self explanatory. It is understood that the campaign data log can contain thousands of records or more depending on the number of campaigns, impressions served and the like. It is also understood that the campaign data log can vary in format without departing from the invention (e.g., a fixed format file as discussed below with respect to the campaign data file).

Transfer of the campaign data log is preferably accomplished by a data transmission utility such as Rsync but can also be accomplished via conventional means including but not limed to FTP, SMTP and the like. The transfer is preferably initiated by the ad delivery engine 24. In the alternative, transfer of campaign data log can be initiated by the central ad planning server 30. Preferably, the campaign data log is transferred to the central ad planning server at least once a day. This ensures that the central ad planning server can run daily reports with reasonable timeliness. The campaign data log can be transferred more frequently (e.g., for relatively busy Web sites) or less frequently (e.g., for less busy Web sites) without departing from the invention.

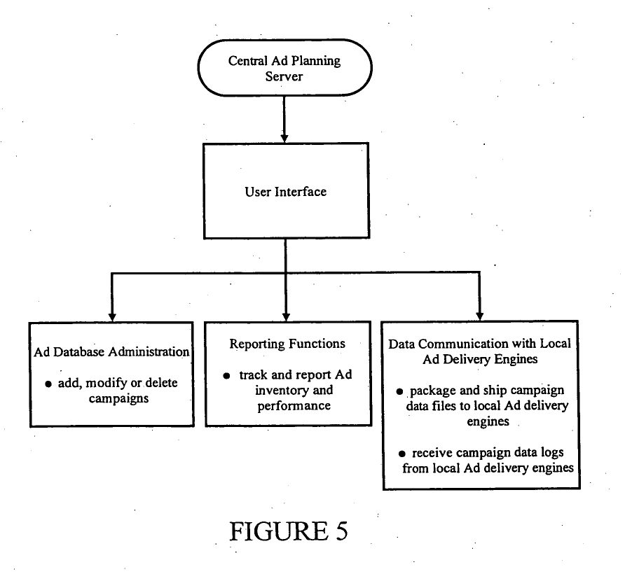

FIG. 5 is a block diagram showing the basic functionality of a central ad planning server 30 in accordance with the invention. The central ad planning server provides three basic functions, database administration, reporting functions, and data communications with the local ad delivery engine 24. A user interface generally provides user access, control and/or configuration of central ad planning server functions.

The central ad planning server 30 is preferably associated with a plurality of advertisers and content provider servers. Accordingly, the user interface is preferably accessed by users having a previously issued user ID and password. Further, the central ad planning server provides appropriate security as needed. For example, advertisers ordinarily only need access to central ad planning server reporting functions. In contrast, content providers ordinarily only need access to central ad planning server database administration functions and/or reporting functions. The central ad planning server user interface is preferably provided via an Internet Web page so that content providers and advertisers can access the user interface remotely.

Central Ad Planning Server—Ad Database Administration

The central ad planning server 30 preferably includes a database 32 of advertisement campaigns. Installation, operation and control of the central ad planning server database 32 and all associated hardware and software under control of a third party. The term “central” as used herein generally refers to an “out-sourced” configuration in which the central ad planing server is installed and operated at a remote location, separated from the content provider and/or advertiser Web sites. Accordingly, the term “central” as used herein denotes that a particular party (e.g., a third party) has control over specific elements of the system.

The central ad planning server is operable to serve campaign data files to a plurality of content providers. Thus, any changes to a given advertisement campaign (e.g., additions, deletions, modifications to ad delivery parameters, scheduling and the like) are made in the central ad planning server database 32. A user interface is provided for management of data associated with the advertisement campaigns. The user interface is operable to allow addition, modification and/or deletion of ad campaigns. Thus, an advertiser wishing to place an advertisement on a plurality of content provider Web sites need only insert a single database record identifying the advertisement campaign and the desired content provider Web sites (assuming they have access to the central ad planning server). The system will then automatically package and transmit a campaign data file to insert an ad campaign in the local campaign data associated with each of the identified content provider Web sites. Similarly, an advertiser or content provider wishing to change advertisement campaign parameters (e.g., to re-target a campaign based on poor performance) need only modify a single database record. The system will then automatically package and transmit a campaign data file to update the ad campaign parameters in the local campaign data associated with each of the identified content provider Web sites.

Central Ad Planning Server—Data Communications

The central ad planning server is operable to periodically transmit (to the ad delivery engine) at least a portion of the database to a plurality of local ad delivery engines for incorporation into local ad campaign data. As stated above, the database information is packaged in a campaign data file that identifies the active advertisement campaigns and all associated parameters (e.g., targeting data, scheduling data and the like).

An exemplary campaign data file 110 is shown if FIG. 4. In this example, the campaign data file is a fixed format, comma delimited text file having several records 114, 116, 118. Preferably, the campaign data file includes a plurality of records in a fixed format (e.g., as shown at 112). It is understood that the campaign data file is not limited to the example shown in FIG. 4 and can include records having a plurality of different fields. In this example, each record includes a campaign ID, up to three targeting parameters, campaign start date, campaign stop date, the number of impressions to be served, the days of the week campaign data should be served, and the hours the campaign data should be served. For example, a record 114 identifies the campaign (123), targeting parameters (Men in 30's and Sports Section of Web site) a start date (Jul. 21, 2000) a stop date (Jul. 28, 2000) the number of impressions (2500), the days of the week campaign data should be served (Monday through Friday), and the hours the campaign data should be served (7 am-7 pm). Based on the foregoing, the remaining data records are self explanatory. It is understood that the campaign data file can contain dozens of records or more depending on the number of campaigns and the like. It is also understood that the campaign data file can vary in format without departing from the invention (e.g., a variable format file as discussed above with respect to the campaign data log).

The central ad planning server is also operable to periodically receive campaign data logs from a plurality of local ad delivery engines. This is preferably accomplished by Rsync transfers but can be accomplished via conventional means including but not limited to (HTTP, FTP SMTP and the like).

Central Ad Planning Server—Reporting Functions

The central ad planning server is operable to generate reports based on data in the database. In general, the reports contain data related to ad inventory, ad campaign performance and the like. Campaigns that are performing poorly, or are ahead or behind schedule, may need to be re-targeted. A campaign that reaches its impression goal can be terminated or removed from the database. Reports can also identify an inventory of future ad impressions for future planning. For sites carrying large numbers of advertisement campaigns, it is advantageous to separate these types of reporting functions from the content provider server since substantial computing time is necessary to compile the necessary data and process these types of reports. Similarly it is also advantageous to separate the ad campaign related reporting functions from the advertiser server since substantial computing time is necessary to compile the necessary data and process these types of reports.

Reports can be generated on a periodic basis and automatically transmitted to one or more party or can be initiated under user control. In general, a content provider will require a report or several reports which relate to all campaigns associated with the content provider Web site. In contrast, an advertiser will generally require a report or several reports which relate to the advertiser's ad campaigns (potentially distributed by a plurality of content provider servers).

### ADVANTAGES OF THE INVENTION

Numerous advantages are provided by employing the present invention, a non-exhaustive list is disclosed below. The present invention provides a system and method for providing advertisements to a network user with maximum performance and flexibility for content providers. The content provider can adjust all ad delivery parameters and the like. The invention also provides a system and method for providing advertisements to a network user with minimal database requirements for content providers. The invention also provides a system and method wherein a third party manages the central advertisement database and is responsible for purchasing, installing, maintaining and controlling all database software and hardware including all database management and data archiving tasks. The third party is responsible for maintaining all database related software licenses and upgrades. The third party is responsible for hosting the central ad planning server at a “well connected” facility. The third party is responsible for training, overseeing payroll associated with, and otherwise supervising all personnel required to maintain the database.

The invention also provides an advantageous system and method in which content providers can offload large advertisement related reporting functions. Yet, the content provider can still obtain comprehensive reports from the central ad planning server relating to all active ad campaigns. The invention also provides an advantageous system and method in which advertisers can offload large advertisement related reporting functions. Yet, the advertiser can still obtain comprehensive reports from the central ad planning server relating to all active ad campaigns (potentially distributed by a plurality of content provider servers). These and other advantages are readily apparent, the scope of the invention as claimed is by no means limited to or by the precise advantages recited above.

While this invention has been described with an emphasis upon preferred embodiments, it will be obvious to those of ordinary skill in the art that variations in the preferred devices and methods may be used and that it is intended that the invention may be practiced otherwise than as specifically described herein. Accordingly, this invention includes all modifications encompassed within the spirit and scope of the invention as defined by the claims that follow.

What is claimed:

1. A data network communication system for presenting advertisements to a user comprising:
a user network processing device operable to transmit at least one user request for an advertisement and present advertisements served in response to the user request for an advertisement to the user;
a content provider server having a local ad delivery engine with local ad campaign data, the content provider server being operable to receive the user request for and advertisement, and transmit an advertisement to the user in response to the user request for an advertisement;
a central ad planning server having a database operable to store central ad campaign data, the central ad planning server being operable to periodically transmit at least a portion of the database to the content provider server to update the local ad campaign data.

2. The system of claim 1 wherein the local ad delivery engine is operable to select an advertisement from the local ad campaign data based on at least one of user data, content data, date, time, host name, available campaigns, targeting data and scheduling data.

3. The system of claim 1 wherein the local ad delivery engine is operable to periodically receive a campaign data file containing at least a portion of the database from the central ad planning server.

4. The system of claim 3 wherein the local ad delivery engine is operable to update the local ad campaign data with data from the campaign data file.

5. The system of claim 1 further comprising a campaign data log containing data relating to advertisements served by the local ad delivery engine.

6. The system of claim 5 wherein the campaign data log contains data relating to at least one of an advertisement campaign, user data, advertisement placement, host name, date and time.

7. The system of claim 5 wherein the local ad delivery engine is operable to periodically transmit the campaign data log to the central ad planning server.

8. The system of claim 7 wherein the central ad planning server is operable to update the database based on the campaign data log.

9. The system of claim 1 wherein the database contains data related to a plurality of advertising campaigns.

10. The system of claim 9 wherein the central ad planning server is operable to add, modify or delete data relating to at least one of the plurality of advertising campaigns stored in the database.

11. The system of claim 9 wherein the central ad planning server is operable to generate at least one report based on data contained in the database, the report containing data related to at least one of ad inventory and ad campaign performance.

12. A method of presenting advertisements to a user via a data network comprising:
receiving at least one user request for an advertisement from a user;
transmitting an advertisement to the user in response to the user request for an advertisement via a content provider server having a local ad delivery engine with local ad campaign data;
periodically updating the local ad campaign data via a central ad planning server having a database operable to store central ad campaign data.

13. The method of claim 12 wherein the ad delivery engine is operable to select an advertisement from the local ad campaign data based on at least one of user data, content data, date, time, host name, available campaigns, targeting data and scheduling data.

14. The method of claim 12 wherein the ad delivery engine is operable to periodically receive a campaign data file containing at least a portion of the database from the central ad planning server.

15. The method of claim 14 wherein the ad delivery engine is operable to update the local ad campaign data with data from the campaign data file.

16. The method of claim 12 wherein the ad delivery engine is operable to maintain a campaign data log containing data relating to advertisements served.

17. The method of claim 16 wherein the campaign data log contains data relating to at least one of an advertisement campaign, user data, advertisement placement, host name, date and time.

18. The method of claim 16 wherein the ad delivery engine is operable to periodically transmit the campaign data log to the central ad planning server.

19. The method of claim 18 wherein the central ad planning server is operable to update the database based on the campaign data log.

20. The method of claim 12 wherein the database contains data related to a plurality of advertising campaigns and the central ad planning server is operable to add, modify or delete data relating to at least one of the plurality of advertising campaigns stored in the database.

21. The method of claim 20 wherein the central ad planning server is operable to generate at least one report based on data contained in the database, the report containing data related to at least one of ad inventory and ad campaign performance.
